(19) United States
(12) Patent Application Publication
(10) Pub. No.: US 2003/0055669 A1
(43) Pub. Date: Mar. 20, 2003

(54) Method, system, and software for handling compliance information

(76) Inventors: Shelley P. Ryan, Houston, TX (US); Raymond Keith Frazier, Houston, TX (US)

Correspondence Address: Edward J. Marshall, Simon, Galasso & Frantz, PLLC, P.O. Box 26503, Austin, TX, 78755-0503, US

(21) Appl. No.: 10/219,863

(22) Filed: Aug. 15, 2002

Related U.S. Application Data
(60) Provisional application No. 60/312,777, filed on Aug. 16, 2001.

(51) Int. Cl. G06F 17/60

(52) U.S. Cl. 705/1

(57) ABSTRACT

An intermediary identifies information relevant to a regulated site, and supplies customized forms, reports, etc., to both industry users and regulatory/compliance agencies to facilitate the entry and receipt of compliance data. The intermediary receives compliance data from a particular industry user then validates and delivers that information to as many regulatory agencies as required, with the information provided to each agency being in a format prescribed by that agency. The intermediary then receives a response from the agencies and delivers the response, or a notification of the response, to the industry user, thereby facilitating the exchange of information, forms, and reports between industry and compliance agencies.

### CROSS REFERENCES TO RELATED APPLICATIONS

This application claims the priority of U.S. Provisional Application entitled, “METHOD AND SYSTEM FOR REGULATORY DATA EXCHANGE,” Serial No. 60/312,777, filed on Aug. 16, 2001.

### FIELD OF THE DISCLOSURE

This disclosure relates generally to exchanging information, and more particularly to exchanging compliance information between Industry users and compliance agencies.

### BACKGROUND

The time and effort required to comply with government regulations can be quite considerable, particularly when dealing with regulations requiring a substantial amount of monitoring and paperwork. It is common, particularly in larger organizations, to devote an entire staff of personnel to be sure that reporting, permit, and other paperwork intensive regulations are complied with. The paperwork burden becomes even more substantial when multiple levels of government agencies are involved. For example, if a company desires to open a new manufacturing plant, it is possible that the plans for the plant will need to be approved by federal, state and local government agencies. In addition, because many agencies are organized to enforce regulations within a specific environmental focus, they require separate approval and reporting procedures. For example, a semi-conductor manufacturing plant may require the approval of multiple local government organizations such as a county water board, a regional air quality commission, a municipal stormwater board, and an area wildlife protection council.

Each of these regulatory organizations may require its own permit applications, reports, forms, etc. Each agency is also likely to request that its paperwork be filled out in a particular format that is different from the format required from all the other agencies. To make matters worse, even though each form must be filled out in a unique manner for each agency, much of the data required on the forms will be the same information required on other agencies' forms. The unique requirements of each agency force the hapless business owner to waste money and manpower in order to comply with the many, often duplicative, requests for information.

While some efforts have been made by individual government agencies to publish their forms on the Internet, or otherwise make their forms, pamphlets, and other literature available to industry users, little has been done that actually provides any significant relief for industry in complying with the multiple layers of governmental regulation and paperwork. Therefore, what is needed is a way to allow industry and regulatory agencies to interact in an efficient manner, wherein industry users may be able to reduce their paperwork load, while still complying with the regulatory requirements of multiple levels of government agencies.

### BRIEF DESCRIPTION OF THE DRAWINGS

Various advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of this specification.

FIG. 1 is a relational diagram illustrating how a Compliance Infrastructure Provider can facilitate exchange of information between industry users and regulatory agencies according to an embodiment of the present disclosure;

FIG. 2 is an Information Flow Diagram illustrating the flow of information between a particular industry user and a number of agencies according to an embodiment of the present disclosure;

FIG. 3 is a Block Diagram illustrating the collection of data from an industry user according to an embodiment of the present disclosure;

FIG. 4 is a Block Diagram illustrating the collection of data from a regulatory agency according to an embodiment of the present disclosure;

FIG. 5 is a Flow Chart illustrating a method according to an embodiment of the present disclosure;

FIG. 6 is a screenshot of a Graphic User Interface (GUI) illustrating a navigational screen according to an embodiment of the present disclosure;

FIG. 7 is a screenshot of a GUI illustrating a compliance summary and form selection according to an embodiment of the present disclosure;

FIG. 8 is a screen shot of a GUI illustrating form components for data maintenance according to an embodiment of the present disclosure;

FIG. 9 is a screenshot of a GUI illustrating a confirmation according to an embodiment of the present disclosure; and

FIG. 10 is a diagram illustrating one embodiment of a Processing System used to implement various embodiments of the present disclosure.

### DETAILED DESCRIPTION OF THE FIGURES

The following definitions may be useful in understanding the detailed description of the figures. When considering the following definitions, it will be appreciated that the meaning of the defined words is not intended to be limited to only the exact meaning set forth in the definition. Instead, the words are intended to also include their normal meaning to those skilled in the art.

The term “industry user” is used herein to refer to a company, individual, assign, or other entity that interacts with “compliance agencies.” Generally, an industry user owns, operates, manages, oversees, uses, resides at, or is otherwise associated with a “site.” In many examples below, the term “industry user,” or “user” refers both the a particular individual operating a computer interface, and to the company for which the individual is performing services. It is to be understood that both the individual and the company may be associated with one or more sites.

The term “compliance agency” includes international, federal agencies, state agencies, local agencies, departments, and other groups that promulgate rules and/or regulations relating to “sites.”The rules or regulations set forth procedures, tasks, standards, etc., with which companies, individuals, other governmental entities and the like must conform. However, the term “compliance agency” is also used to refer to companies, governmental agencies, etc. that collect data required by various rules and regulations, and entities that enforce the regulations.

The term “site” or “regulated site” may refer to a fixed geographic location, a building, port, dock, park, or other similar fixed location facility. Additionally, the term “site” may refer to a mobile or moveable object associated with particular regulations or rules that follow that object; for example, a truck, train, ship, or airplane.

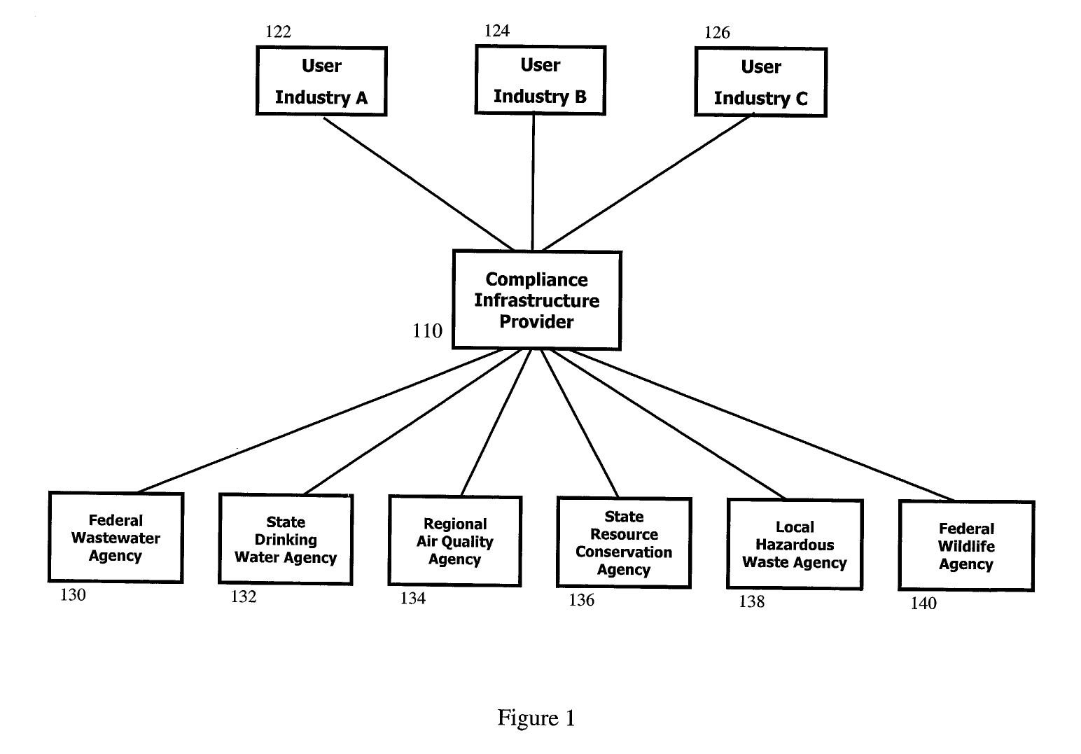

FIGS. 1-10 illustrate a method, system and software for facilitating collection of compliance information, and exchange of that information between industry users and agencies. Information associated with a compliance issue for one or more sites can be obtained from an industry user then provided to a compliance agency via an information network such as the Internet. The agency can then take whatever actions are necessary to process the compliance information received from the industry user, and provide the industry user a response, using the information network or otherwise.

The process of obtaining the compliance information from the industry user can be implemented so that the user is presented with data collection forms having as much information as possible already pre-filled, and being configured so that a particular element of information need only be input one time by the industry user regardless of how many agencies are to receive that information. In addition, the agency's handling of information received from the industry user can be made easier by generating similar data input forms for the agency, and by permitting the agency to interact with the industry user electronically, over an information network such as the Internet.

Referring first to FIG. 1 the use of a Compliance Infrastructure Provider 110 to facilitate the exchange of information between industry users and agencies will be discussed according to an embodiment of the present disclosure. Industry User A 122, Industry User B 124 and Industry User C 126 must comply with various regulations promulgated by Federal Agency for Wastewater 130, State Agency for Drinking Water 132, Regional Agency for Air Quality 134, State Agency for Resource Conservation 136, Local Agency for Hazardous Waste 138 and Federal Agency for Wildlife Protection 140. Each of the agencies 130-140 have particular rules and regulations which must be followed by Industry Users 122-126. Each of the agencies 130-140 also has its own particular forms, reports, and other information requirements that are dictated either by statute, internal regulations, industry standards, or simply by tradition.

Many of the forms, reports and other information required by Agencies 130-140 require information duplicative of information required by other agencies. As is common, in very few cases do any of the agencies share information, or use any type of standardized information formats. In order for Industry Users 122-126 to comply with the regulations promulgated by Agencies 130-140, the Industry Users 122-126 must provide information to those agencies in the various required formats.

Compliance Infrastructure Provider 110 stands between Industry Users 122-126 and Agencies 130-140. Industry Users 122-126 can provide the necessary compliance information to Compliance Infrastructure Provider 110 one time, and Compliance Infrastructure Provider 110 will provide the compliance information from each of the Industry Users to all appropriate Agencies 130-140. By allowing Industry Users 122-126 to input compliance data or information a single time for all necessary agency reports, forms, etc., Industry Users 122-126 can save significant amounts of manpower and money by avoiding duplicative efforts. Once each agency has taken any action necessary, based on the information provided by the Industry Users 122-126, any agency can provide a response to any industry user through Compliance Infrastructure Provider 110.

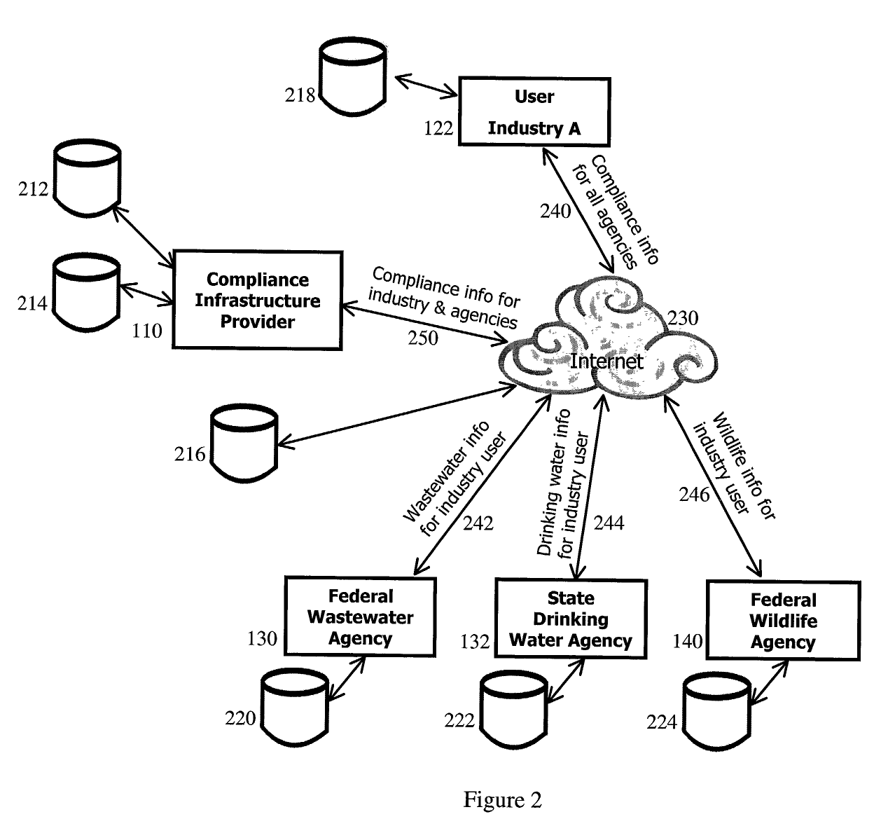

Refer next to FIG. 2, for a more detailed example of information exchange between an industry user and appropriate compliance agencies according to an embodiment of the present disclosure. FIG. 2 illustrates the information flow between Industry User A 122 and Federal Agency for Wastewater 130, State Agency for Drinking Water 132 and Federal Agency for Wildlife Protection 140. In general, compliance information for All Agencies 240 is delivered from Industry User A over an information network, such as Internet 230 to Compliance Infrastructure Provider 110. All compliance info for Industry and Agencies 250 flows first to Compliance Infrastructure Provider 110, and is then distributed to either Industry User A 122 or Agencies 130, 132 and 140. In order to facilitate the exchange of forms, reports and other information between Industry User A 122 and Agencies 130, 132 and 140, Compliance Infrastructure Provider may use Databases 212, 214 or may use a Remote Data Storage Facility 216. Note that Industry User A 122 may have his own Information Database 218 while Agencies 130, 132 and 140 also have their own individual databases 220, 222 and 224 respectively.

Once Compliance Infrastructure Provider 110 has received information from Industry User A 122, Compliance Infrastructure Provider 110 properly formats and parses the Industry User information and delivers Industry User Wastewater compliance info 242 to Federal Wastewater Agency 130, Industry User Drinking Water compliance info 244 to State Drinking Water Agency 132, and Industry User Wildlife Protection compliance information 246 to Federal Wildlife Agency 140 as appropriate. User information delivered to each particular Agency 130, 132 and 140 is in the format required by that particular agency. For example, if Federal Wastewater Agency 130 requires a permit request to be in a particular government mandated format, then Compliance Infrastructure Provider 110 takes the information provided by Industry User A 122 puts that information into the required government format and delivers the information to Federal Wastewater Agency 130.

Note, that in other embodiments, Compliance Infrastructure Provider 110 may deliver a hard copy of the form, rather than deliver the information electronically as illustrated in FIG. 2. Delivering a hard copy may be necessary or beneficial if the particular agency to which the report, form or other information is being provided does not accept electronic transfers of information. In such a case, Industry User A 122 can still provide compliance information for All Agencies 240 to Compliance Infrastructure Provider 110 and Compliance Infrastructure Provider 110 will deliver the information electronically to any agencies accepting electronic information transfers, and deliver the information in hard copy format to those agencies not accepting electronic information.

The remainder of this discussion will deal with the case in which both the Industry User and the appropriate compliance agencies all use fully electronic information transfer. However, it is to be understood that fully electronic information transfer use by all parties is not required in all circumstances, and either Industry User A 122 or Agencies 130, 132 or 140 may benefit from the teachings set forth herein regardless of whether all parties involved use fully electronic information transfer.

Consider the following example in which Industry User A 122 must report compliance issues raised by an internal audit to Agencies 130, 132 and 140. Assume that Industry User A 122 has performed an internal audit in compliance with various state and federal regulatory requirements. Industry User A 122 may collect the audit information and store it in its own Database 218 using various suitable methods which are commonly known. However, in one embodiment of the present disclosure, when conducting the internal audit Industry User A 122 may request an audit form from Compliance Infrastructure Provider 110. Compliance Infrastructure Provider 110 searches Databases 212 and 214 to determine which compliance agencies must be notified of the results of Industry User A 122 internal audit.

In searching Databases 212 and 214, Compliance Infrastructure Provider 110 determines that Federal Wastewater Agency 130, State Drinking Water Agency 132 and Federal Wildlife Agency 140 must all be notified of the results of the internal audit conducted by Industry User A 122. Compliance Infrastructure Provider 110 then presents Industry User A 122 with data entry forms required by all three Agencies 130, 132 and 140. Industry User A 122 may select one of the three electronic forms provided by Compliance Infrastructure Provider 110 and input the necessary audit data. When Industry User A 122 selects the second form, Compliance Infrastructure Provider 110 prefills the second form with duplicative information from the first form. Likewise, when Industry User A 122 selects the third form, Compliance Infrastructure Provider 110 prefills the third form with duplicative information from the first and second forms.

The information collected by Industry User A 122 during its internal audit may be stored in its own Database 218, or may be transmitted as it is collected to Compliance Infrastructure Provider 110 for storage in Databases 212, 214 or 216. Once all necessary information has been collected by Industry User A 122 and delivered to Compliance Infrastructure Provider 110, Compliance Infrastructure Provider 110 will format the information and deliver it to the appropriate Agencies 130, 132 and 140, in the appropriate format for each agency.

Alternatively, the data collected may be stored in a database such as Database 216, which is accessible to Agencies 130, 132, and 140. A notification may then be provided to Agencies 130, 132, and 140 by Compliance Infrastructure Provider 110. Upon receipt of the notification, any of the Agencies 130, 132, or 140 can then retrieve the stored information when convenient. In at least one embodiment, the database in which the data is stored is a database under the control of one or more of the Agencies 130, 132, or 140.

Upon receipt of the information from Compliance Infrastructure Provider 110, Agencies 130, 132 and 140 may store that information in their own Databases 220, 222 or 224 respectively, and may then evaluate the data as needed. Note that the information provided by Compliance Infrastructure Provider 110 to Agencies 130, 132 and 140 can be collected and/or delivered in a format that is compatible with the data systems of both the compliance agencies and the industry user, such that there is a minimum of compatibility issues to be dealt with by either the agencies or the industry user.

In the case where a particular agency uses a Legacy System, the information delivered from Compliance Infrastructure Provider 110 may be received by the Agency, stored in the appropriate Database 220, 222 or 224, and then acted upon within the Agency using the Agency's own internal software or other procedures. Once the Agency 130, 132 or 140 has evaluated the information provided by Industry User A 122, the Agency can then provide an appropriate response to Industry User A 122 through Compliance Infrastructure Provider 110. In other embodiments, Compliance Infrastructure Provider 110 may provide data entry forms to Agencies 130, 132 or 140 in order to facilitate the evaluation, response, reporting, and other similar functions performed by Agencies 130, 132 or 140.

In addition to collecting and configuring information to facilitate data exchange between Industry User A 122 and Compliance Agencies 130, 132, and 140, Compliance Infrastructure Provider 110 may also perform various validation functions. In one embodiment, validation includes authenticating the identity of Industry User A 122 prior to accepting any information, and then verifying he accuracy of information provided. For example, Industry User A 122 may be required to provide a unique password prior to data being accepted by Compliance Infrastructure Provider 110. Alternatively, other forms of authentication, such as unique identifiers embedded in communication software, verification of Internet Protocol addresses, requiring data to be encrypted using public key software, etc. may be used alone or in conjunction with other authentication methods known to those skilled in the art to validate the identity of Industry User A 122.

In at least one embodiment, once the identity of Industry User A 122 is confirmed, the data received is checked for accuracy. For example, data may be processed through a dictionary program to ensure that no words are misspelled. Data can also be cross checked against previously submitted data to ensure that two digits of a regulated site's industry classification are not inadvertently transposed. Additionally, the data may be evaluated for consistency of usage, to prevent possible confusion based on assumed equivalents. For example, if a site is owned by “Widgets 4U, Inc.” and the submitted data indicates simply “Widgets 4U,” then the data may be either flagged, corrected, or otherwise dealt with. It will be appreciated that although many errors of this type can be avoided by eliminating the need for redundant data entry, such a validation process may prove valuable in various circumstances.

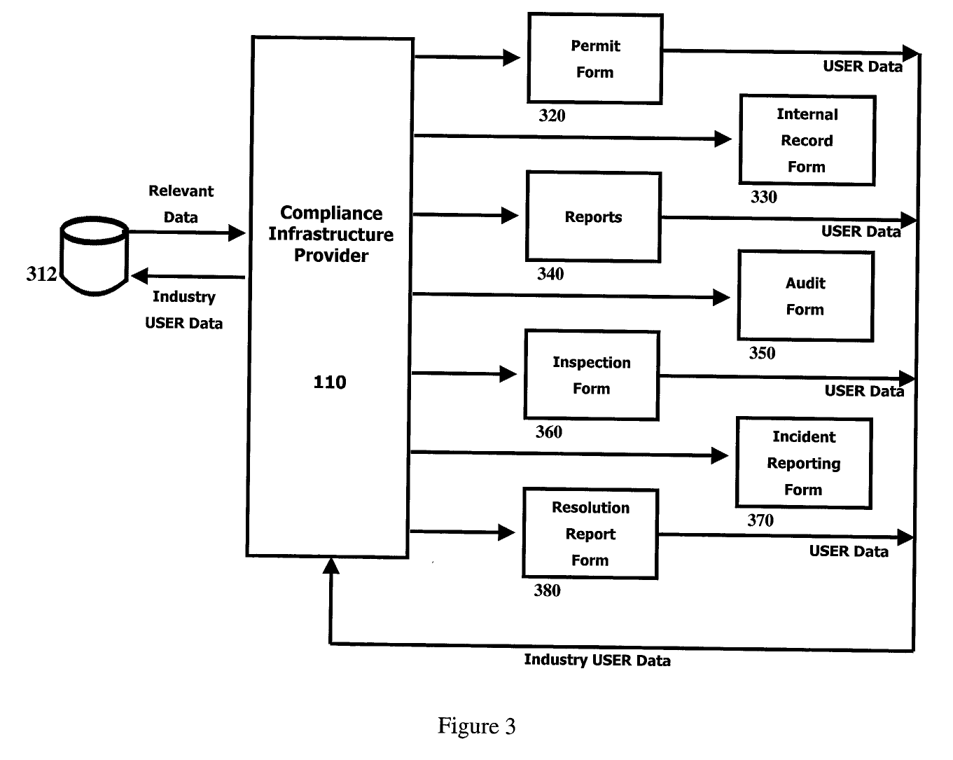

Referring next to FIG. 3, collection of Industry User Data will be discussed according to an embodiment of the present disclosure. In one embodiment, Industry User Data 390 may be collected by an Industry User using any of the various methods known to those skilled in the art. The information collected can then be delivered to Compliance Infrastructure Provider 110 in a bulk data transfer. However, in other embodiments, Compliance Infrastructure Provider 110 provides data collection forms to facilitate collection of Industry User Data 390. For example, Compliance Infrastructure Provider 110 may provide Permit Form 320, Internal Record Form 330, Audit Form 350, Inspection Form 360, Incident Reporting Form 370, Resolution Report Form 380, a notification form (not illustrated) or any number of other forms that may be useful in facilitating collection of Industry User Data 390.

When an Industry User desires to use data entry forms as taught herein, Compliance Infrastructure Provider 110 can provide the necessary forms based on relevant information retrieved from Database 312. The relevant information retrieved from Database 312 may include information such as the following: the physical location of the site associated with the industry user; the regulatory jurisdictions in which the site may be found; the industry classification of the site; the compliance issue for which data is to be collected; a history of the site, particularly as that history relates to the compliance issue involved; a history of the Industry User's interaction with particular Compliance Agencies; and similar information. The compliance issue may be a permit requirement, a record keeping requirement, a monitoring requirement, a reporting requirement, an audit, an inspection, an incident, an enforcement action, a notification or some other similar compliance issue.

By retrieving relevant information from Database 312, Compliance Infrastructure Provider 110 can present relevant forms to the Industry User, while avoiding extraneous forms. In addition, Compliance Infrastructure Provider 110 may customize each provided form to include only requests for relevant information. For example, if a particular compliance agency requires a particular piece of information only from a regulated site with more than 500 employees, then Compliance Infrastructure Provider 110 can determine the number of employees at a particular regulated site and request the information from the industry user only if the site has more than 500 employees.

Additionally, Compliance Infrastructure Provider 110 may pre-fill information in the data entry forms, thereby lightening the data entry workload for the industry user. For example, if the industry user requests an Incident Reporting Form 370 to report an environmental spill that occurred during construction of a manufacturing facility, then Compliance Infrastructure Provider 110 might retrieve from Database 312 information submitted by that Industry User when that Industry User filed its request for a permit before construction of the site. Any information can be pre-filled on Incident Reporting Form 370 if that information was already input by the Industry User on Permit Form 320. Likewise, Compliance Infrastructure Provider 110 may pre-fill Permit Form 320 with any previously entered data. Once the Industry User is ready to submit his Industry User Data 390, Compliance Infrastructure Provider 110 saves Industry User Data 390 to Database 312 for later use, or for electronic delivery or otherwise, to the appropriate compliance agency.

In addition to Data Entry Forms 320, 330, 350, 360, 370 and 380, Compliance Infrastructure Provider 110 may also present the Industry User with informational forms such as Reports 340. Reports 340 may be requested by the Industry User, or Compliance Infrastructure Provider 110 may present Reports 340 to the Industry User automatically upon receipt of the information from a compliance agency. Compliance Infrastructure Provider 110 may also provide notifications (not illustrated) to notify an Industry User of a pending deadline, to notify the Industry User that an agency has completed an evaluation, etc.

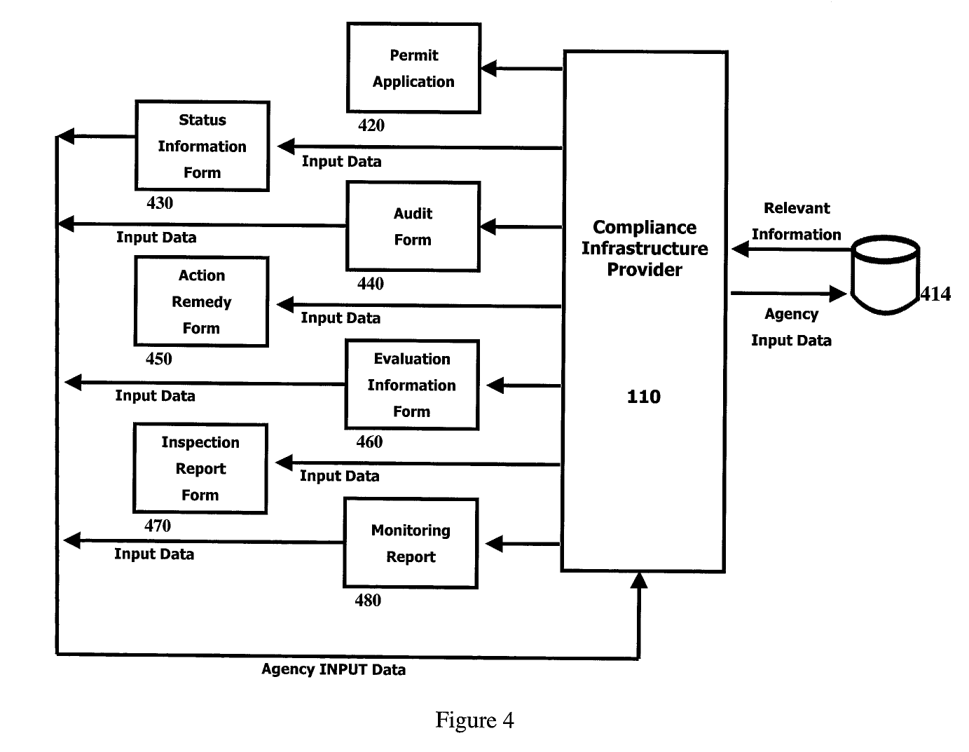

Referring next to FIG. 4, the provision of forms to an agency by Compliance Infrastructure Provider 110 will be discussed according to an embodiment of the present disclosure. Upon receipt of information from an Industry User, or at any other time when an agency action on a compliance issue is required, a compliance agency may request Compliance Infrastructure Provider 110 to provide data entry forms. These forms may be used to facilitate submission of data to Compliance Infrastructure Provider 110, or in the performance of some other agency task. As was the case when providing forms to an Industry User, Compliance Infrastructure Provider 110 first retrieves relevant information from Database 414. This relevant information may include the name of an agent to whom a particular issue has been assigned, the status of a particular issue, a remedial action that has been taken in regard to a particular issue, an evaluation of a permit or other information submitted by an Industry User, a resolution of an issue, a penalty assessed for a violation, or other similar information. The Compliance Infrastructure Provider 110 will then provide to the agency a data input form such as Status Info Form 430, Audit Form 440, Action/Remedy Form 450, Evaluation Information Form 460, Inspection Report Form 470 or the like.

An agent assigned to handle an issue associated with a requested form may enter data, and deliver Agency Input Data 490 to Compliance Infrastructure Provider 110 for storage in Database 414 and/or delivery to an Industry User. For example, if an agency is performing an audit on an Industry User, the agent assigned to perform the audit could request an Audit Form 440 to be provided by Compliance Infrastructure Provider 110. Compliance Infrastructure Provider 110 retrieves relevant information from Database 414 and generates a customized Audit Form 440, including pre-filled information where available. In this example, if the audit being performed is a follow-up audit, then information from the first audit, even if not performed by the same agent, can be included in Audit Form 440. By including the information from the previous audit, the data entry requirements of the agent assigned to perform the audit can be significantly lessened.

The agent can download the Audit Form 440 onto a portable information gathering device such as a laptop computer, and then carry that device with him to the audit. As the agent performs the audit he can enter data as needed into any fields that are not pre-filled. After the audit, the agent can simply connect his portable device to an information network to deliver Agency Input Data 490 to Compliance Infrastructure Provider 110. Compliance Infrastructure Provider 110 can then deliver the results of the audit to the Industry User being audited, or notify the Industry User that the audit results are available. All of this can be accomplished requiring a minimum of duplicative data entry effort.

In addition to Data Entry Forms 430, 440, 450, 460 and 470, Compliance Infrastructure Provider 110 may also provide information forms such as Permit Application 420, and Monitoring Report 480. Informational forms 420, 480 and similar forms may be used to provide the agency with information supplied by an Industry User. These informational forms can be used in conjunction with data entry forms if desired, to aid the agency in simplifying workflows. For example when Permit Application 420 is received at the agency, Compliance Infrastructure Provider 110 may automatically generate a Status Information Form 430. Both Permit Application Form 420 and Status Information Form 430 may be delivered to an agent who is responsible for the case. The responsible agent could then, for example, simply check a box on Status Information Form 430 to indicate that the Permit Application was received. The agent can then submit the form to Compliance Infrastructure Provider 110, who will in turn provide a notification to the Industry User that his Permit Application was received by the agency. In one embodiment, the Status Information Form 430 contains multiple fields, and the agent may request Status Information Form 430 to be displayed at various points during the processing of Permit Application 420, such that the status of Permit Application 420 can be easily tracked both internally and by the Industry User.

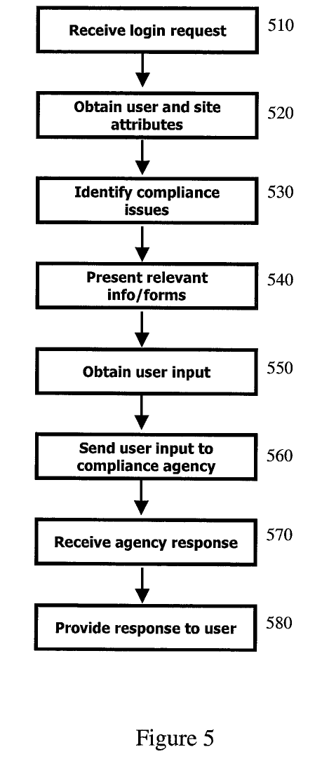

Referring next to FIG. 5 a method according to an embodiment of the present disclosure will be discussed. The method begins at Step 510, in which a login request is received from a user. The login request may be used to verify the identity of a user, and to provide one level of security protection. Various methods of receiving a login request from a user are known to those skilled in the art. The method next proceeds to Step 520, in which user and site attributes are obtained. These attributes may include the geographical location of a regulated site associated with the user, the industry classification of the regulated site, the compliance history of the site, the compliance history of the user, as well as other relevant information that may be used to aid in the selection of forms and information to present to the user.

The method then proceeds to Step 530, in which compliance issues are identified. The step of identifying compliance issues may include identifying a responsible compliance agency, compliance requirements of the responsible compliance agency, as well as any previously identified compliance issues based on previous inspections, audits and the like. Once compliance issues have been identified in Step 530, the method proceeds to Step 540 wherein relevant information and forms are presented to the user. In at least one embodiment, forms and information are presented to a user using a graphical user interface, such as a web browser.

In at least one embodiment, only relevant forms are presented to a user, and only relevant information is included on those forms. For example, an regulated site dealing with only industrial cleaning products would not be likely to be required to provide compliance data to the Food and Drug Administration. However, that site would likely be required to provide information to the Environmental Protection Agency. Therefore only forms and data fields required of the regulated site by the Environmental Protection Agency will be displayed to the user, while any data not required by the Environmental Protection Agency would not.

After the relevant forms are displayed to the user in Step 540, user input is obtained in Step 550. User input may be obtained using the graphical user interface, a text interface, or any other suitable interface. However, in at least one embodiment information is obtained from a user via drop-down menus, user selectable objects displayed on a computer screen, or other similar methods known to those skilled in the art. After all the data has been obtained from the user in Step 550, the user's input is sent to the compliance agency in Step 560. Sending input to the compliance agency may require the user to send the information to an intermediary, such as Compliance Infrastructure Provider 110 (FIGS. 1-4). However, in other embodiments in which the user sends the data to one or more compliance agencies, the transmission of user input to the compliance agency appears to be a seamless, one-step process, whether an intermediary is used to facilitate data transfer or not.

After the user's input is delivered to the compliance agency in Step 560, the next step is to receive the agency's response, as shown in Step 570. The agency's response may be delivered to an intermediary, and upon receipt of the agency's response, the intermediary may notify the user or provide the agency's response to the user as in Step 580. In this way the exchange of forms, information and reports between regulated sites and government compliance agencies, such as environmental regulatory agencies, can be streamlined.

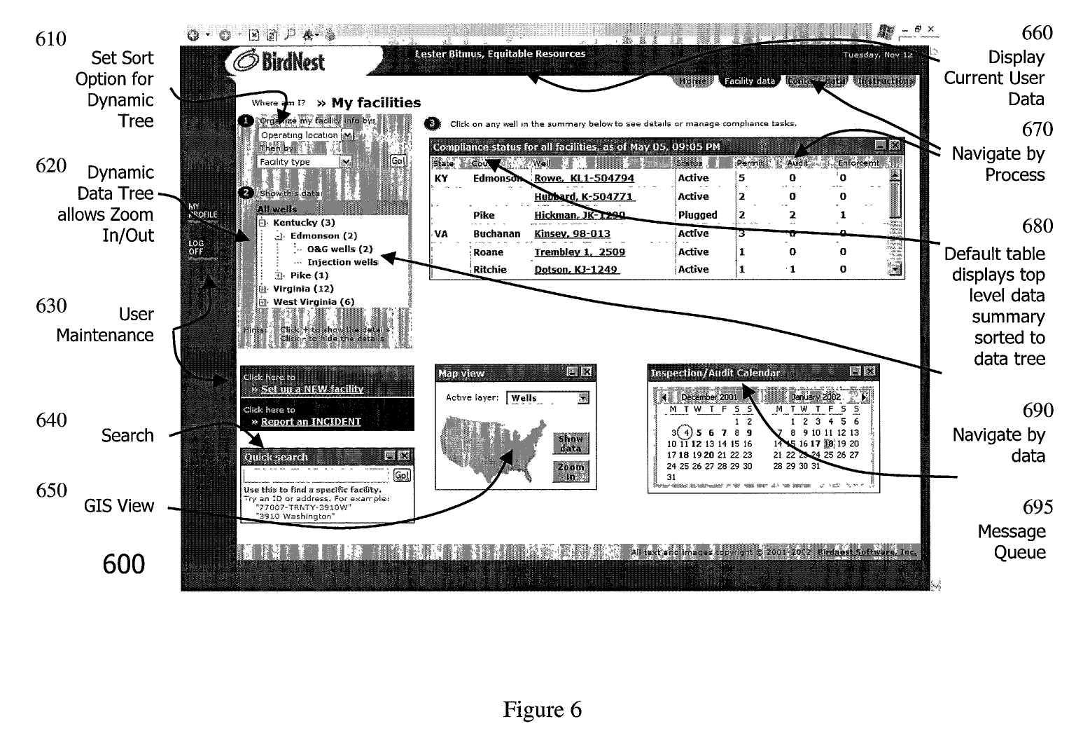

Referring next to FIG. 6, a screenshot illustrating a Graphical User Interface (GUI) according to an embodiment of the present disclosure is illustrated, and designated generally Screenshot 600. Screenshot 600 shows a GUI that a user may employ to navigate to other screens used for data entry, data viewing or other similar uses. For example Screenshot 600 includes Item 610 which sets Sort Options for the Dynamic Tree 620. Dynamic Data Tree 620 provides user selectable objects such as Navigate By Data Object 690, which allow a user to select an object and cause associated data screens to be displayed. Various user maintenance objects, such as Log Off 630, are also provided to allow a user to perform various administrative functions, such as ending a session. Search Area 640 is provided to allow a user to navigate to particular displays or elements of data if the user knows the name or title of the data he is seeking. GIS View Object 650 provides a map view showing where particular facilities associated with the user may be located geographically. Message Que 695 illustrates an Inspection/Audit Calendar, which is provided as a prompt for a user so that important dates can be easily remembered. Additionally, Default Table 680 displays a top-level data summary, and is sorted according to the selection indicated in Dynamic Data Tree 620. Various other Navigation Objects 670 are provided to allow alternate methods of navigating to different display screens. Finally User Data Area 660 displays the user's identity to indicate who is logged into the current session.

It will be appreciated that various elements shown in Screenshot 600 may be altered without departing from the spirit and scope of the invention disclosed herein. For example, additional or fewer user selectable objects may be provided, the appearance, color, size, and location of various objects may be changed, and various items may be displayed in Message Que 695 in addition to or in place of the Inspection/Audit Calendar as illustrated in FIG. 6.

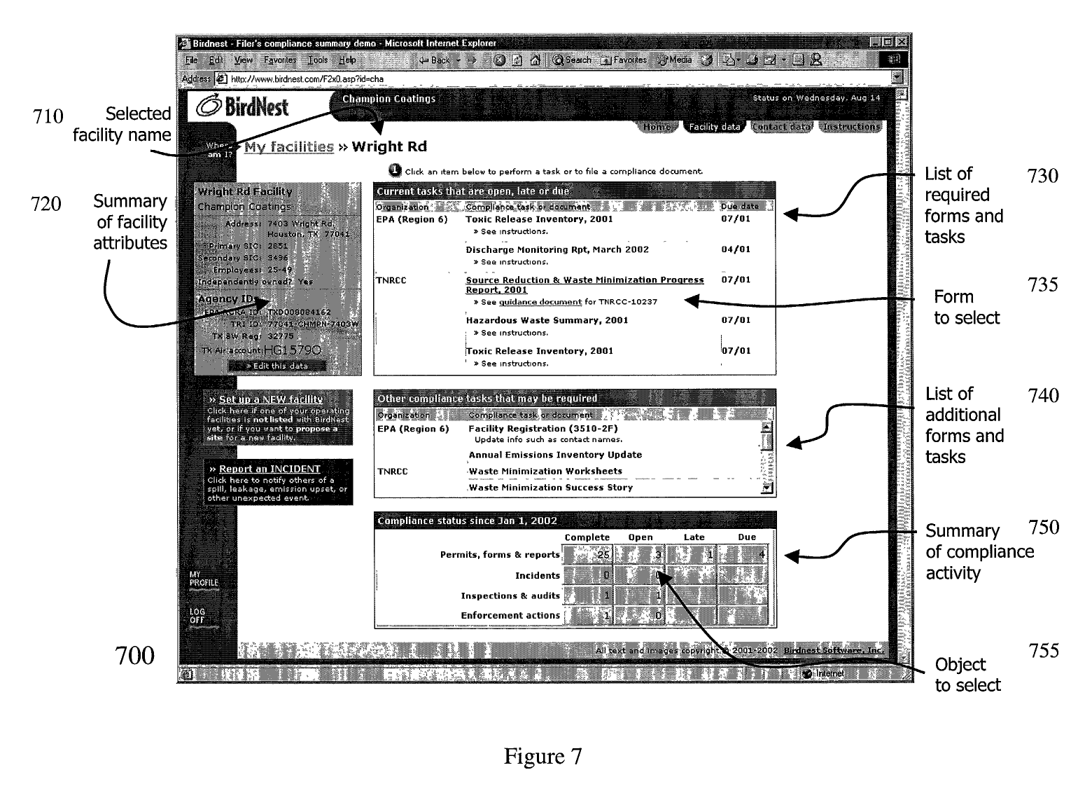

Referring next to FIG. 7 a GUI for form/task selection is illustrated and is designated generally Screenshot 700. Screenshot 700 includes the name of the regulated site or facility selected by the user 710, which in this example is Wright Road, and a summary of the facility's attributes 720. List 730 displays required compliance forms and tasks for the selected facility. Within list 740, additional permits, forms and notices that may be appropriate to the selected facility are displayed. In the illustrated embodiment, if a user desires to access one of these displayed forms, he can simply select the appropriate form. For example, TNRCC is a Texas regulatory organization that requires an annual Waste Minimization Progress Report 735 from the Champions Coating facility on Wright Road. A user may simply select the form 735 to navigate to the appropriate data entry form.

A summary of compliance activity associated with the selected facility appears in Summary area 750. For example, Summary area 750 shows the number of open, pending and closed permits and forms, incidents, monitoring reports, inspections and audits, and enforcement actions, that are associated with facility name 710. In addition, Summary area 750 provides user selectable objects, such as example object 755, that allow a user to navigate to appropriate data screens when those user selectable objects are chosen.

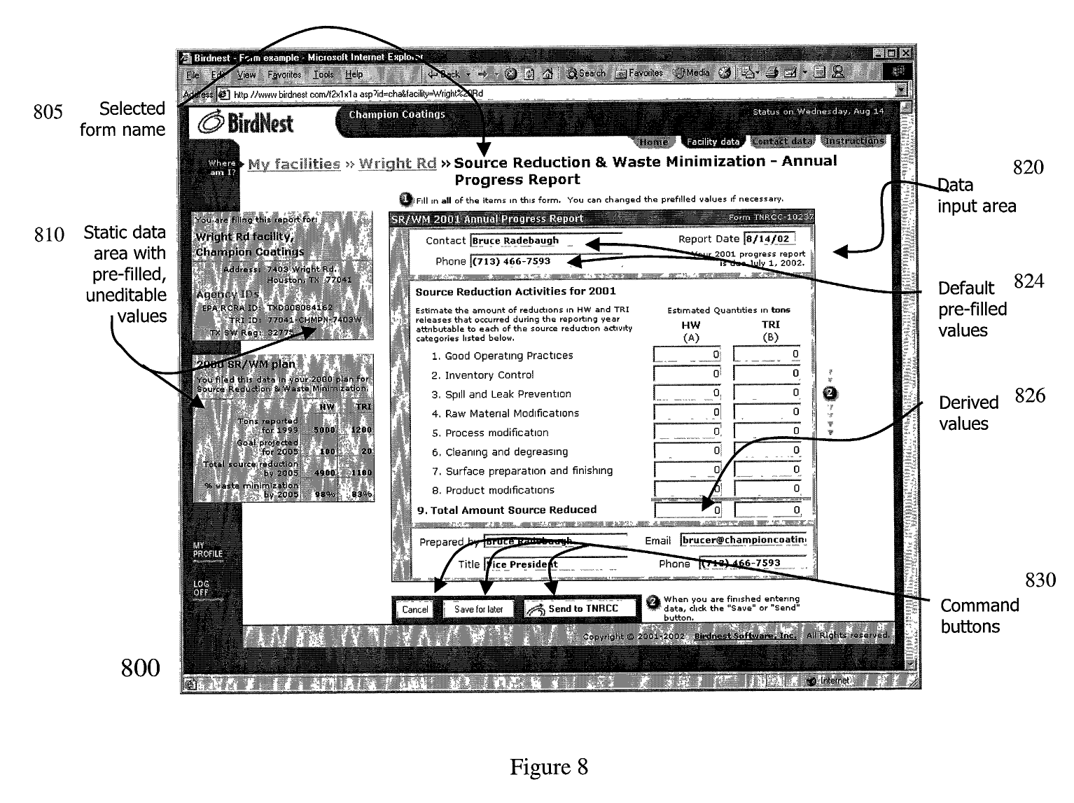

Referring next to FIG. 8, a GUI for use in data maintenance/entry is illustrated, and designated generally Screenshot 800. Elements 810-826 shown in Screenshot 800 represent the selected form, which in this example is a Source Reduction and Waste Minimization Progress Report 805. The Static Data Area 810 displays information which is already in the system and which applies to the selected form. In at least one embodiment, the data displayed in Static Data Area 810 is not editable using the illustrated screen. The Data Input Area 820 includes various drop-down fields, lists, fill-in fields, etc., in which the user inputs the necessary information. Some fields in area 820 are pre-filled with default values, such as the Contact name 824, which the user can edit. Some fields automatically derive or calculate values, such as the Total Amounts 826. Command buttons 830 enable the user to cancel the task, save the incomplete task, or send the completed form to the appropriate compliance agency.

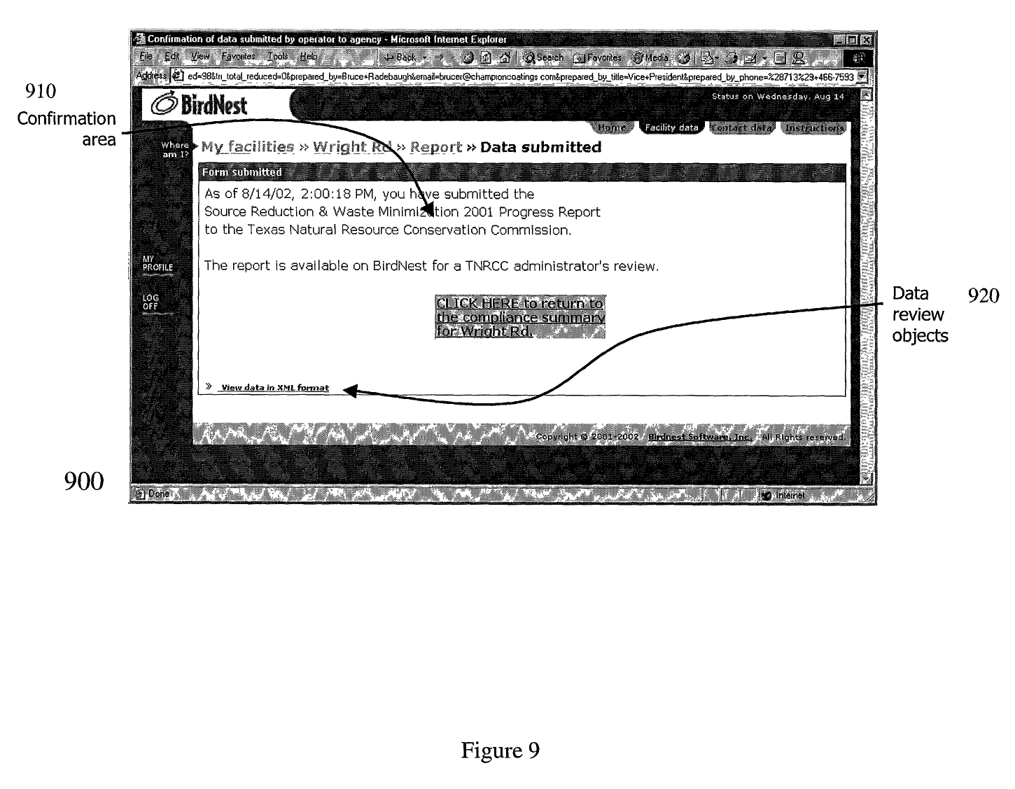

Referring next to FIG. 9, Screenshot 900 is illustrated. Screenshot 900 shows a GUI screen, which may be used to provide confirmation that particular actions have been taken. For example, Confirmation Area 910 indicates that a report has been submitted to a particular compliance agency. Data Review objects 920 enable the user to navigate to the appropriate screens to examine the submitted data in different formats, such as the XML example shown. Screenshot 900 also provides many of the navigation elements previously discussed with respect to FIGS. 6-8.

In at least one embodiment of the present disclosure, a web browser may be used to interface with a compliance intermediary, such as Compliance Infrastructure Provider 110 (FIGS. 1-4). In other embodiments, however, industry users and agencies may use internal data entry mechanisms, and download data in bulk to the compliance intermediary. While bulk downloaded data does not provide all of the benefits that would be available if the dynamic data entry screens discussed herein were used, direct download is within the spirit and scope of the present disclosure.

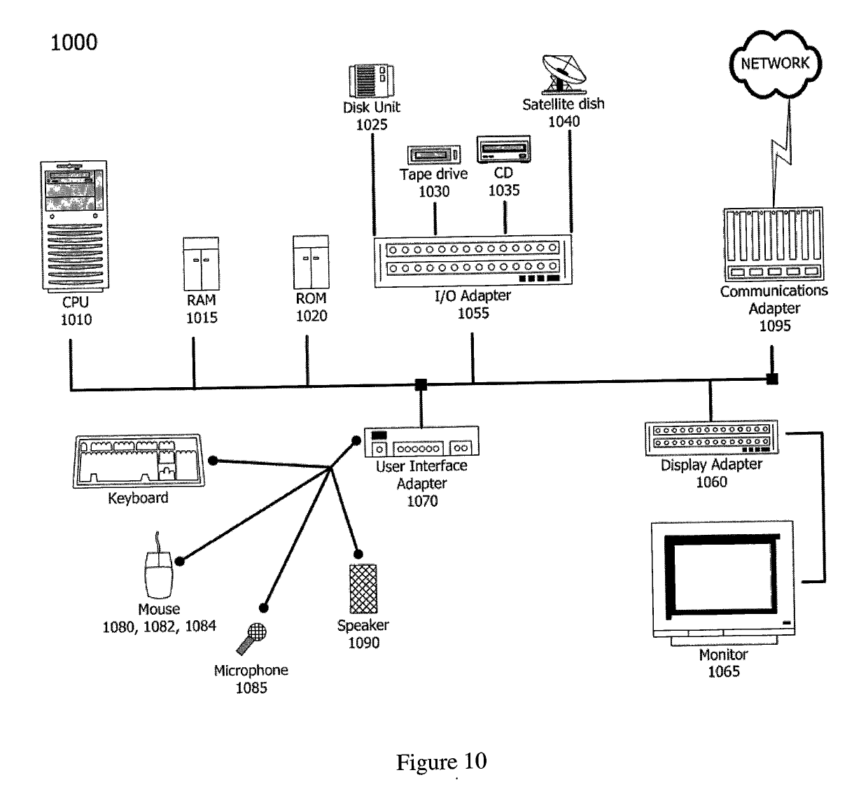

Referring next to FIG. 10, a processing system is depicted, and is designated generally by Reference Numeral 1000. As illustrated, processing system 1000 comprises a Central Processing Unit 1010, such as a conventional microprocessor, and a number of other units interconnected via at least one System Bus 1050. The interconnected units include Random Access Memory (RAM) 1015, read-only Memory (ROM) 1020, wherein ROM 1020 could also be Erasable-Programmable read-only Memory (EPROM) or Electrically Erasable-Programmable read-only Memory (EEPROM), input/output (10) Adapter 1055 for connecting peripheral devices such as Disk Units 1025, Tape Drives 1030, CD or DVD player recorders 1035, or Satellite Receiver 1040 to System Bus 1050, User Interface Adapter 1070 for connecting Keyboard 1075, Mouse 1080, Speaker 1090, Microphone 1085, and/or other user interface devices to System Bus 1050, communications adapter 1095 for connecting Processing System 1000 to an information network such as the Internet, and Display Adapter 1060 connecting System Bus 1050 to a Display Device such as Monitor 1065. Mouse 1080 has a series of buttons 1082, 1084, and is used to control a cursor shown on Monitor 1065. It will be understood that Processing System 1000 may compromise other suitable data processing systems without departing from the scope of the present invention.

In summary then, a compliance infrastructure provider (intermediary) can provide customized forms, reports and other information to industry users and agencies to facilitate the collection of information related to compliance issues. The forms are selected to be relevant, based on the compliance issue, the type of industry, a site's history, geographical location and other similar information. The relevant forms are then further customized to include only relevant data and data entry fields based on generally similar criteria as those criteria used to select the forms, and as much information as possible is pre-filled onto the forms. The compliance data need only be entered one time by a user, because the intermediary can format the data appropriately for delivery to multiple compliance agencies. The information provided by an industry user can then be delivered to as many agencies as necessary in the appropriate format, so that agency can take necessary actions and respond to the industry user.

In at least one embodiment all communication takes place via an information network, so that exchange of reports and forms between industry and government agencies is as streamlined as possible. The intermediary can maintain all the data provided by the industry user and all the data provided to the industry user from the compliance agencies, thereby enabling users and compliance agencies to easily manage the information while reducing the vast amount of paperwork required.

In the preceding detailed description of the figures, reference has been made to the accompanying drawings, which form a part thereof, and in which is shown by way of illustration specific embodiments in which the disclosure may be practiced. These embodiments are described in sufficient detail to enable those skilled in the art to practice the disclosure, and it is to be understood that other embodiments may be utilized and that logical, mechanical, chemical, and electrical changes may be made without departing from the spirit or scope of the disclosure. For example while particular criteria for determining relevant forms in data are discussed in the above disclosure, additional suitable criteria may be used as desired, and in some cases the use of fewer criteria may be desirable. Additionally, while the above disclosure focuses primarily on a two-way exchange of information between industry and government agencies, various portions of the above disclosure may be utilized individually to obtain some of the benefits discussed herein.

Furthermore, many other varied embodiments that incorporate the teachings of the disclosure may be easily constructed by those skilled in the art. For example, although an internet browser has been illustrated as the primary GUI, any other suitable interface may also be used to implement the teachings set forth herein. To avoid detail not necessary to enable those skilled in the art to practice the invention, the description may omit certain information known to those skilled in the art. Accordingly, the present disclosure is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present disclosure is defined only by the appended claims.

What is claimed is:

1. A method comprising:
obtaining, from an industry user via an information network, information to be delivered to a plurality of compliance agencies; and
delivering the information to at least one compliance agency of the plurality of compliance agencies via the information network.

2. The method as in claim 1, wherein the information is non-duplicative.

3. The method as in claim 1, further including validating the information to be delivered.

4. The method as in claim 3, wherein validating includes verifying accuracy of the information.

5. The method as in claim 3, wherein validating includes authenticating a source of the information.

6. The method as in claim 1, further including:
obtaining, from a compliance agency via an information network, information to be delivered to the industry user; and
delivering the information to the user via the information network.

7. The method as in claim 6, wherein delivering information to at least one of the plurality of compliance agencies and delivering information to the industry user are performed as part of a series of related transactions.

8. The method as in claim 1, wherein:
the information obtained from the industry user is in a form compatible with a data system of the industry user; and
the information is delivered to the at least one compliance agency in a form compatible with a data system of the at least one compliance agency.

9. The method as in claim 1, wherein delivering the information to the at least one compliance agency includes:
notifying the at least one compliance agency that the information has been obtained from the industry user;
receiving a reply to the notification from the at least one compliance agency; and
providing the information to the at least one compliance agency in response to the reply.

10. The method as in claim 1, wherein delivering the information to the at least one compliance agency includes storing the information in a database accessible to the at least one compliance agency.

11. The method as in claim 10, wherein the database is part of a data system of the at least one compliance agency.

12. The method as in claim 1, wherein obtaining information from the industry user includes:
identifying information relevant to the compliance requirement; and
presenting the relevant information to the industry user.

13. The method as in claim 12, wherein identifying relevant information includes identifying a responsible compliance agency.

14. The method as in claim 13, wherein identifying a responsible compliance agency includes applying a jurisdictional boundary.

15. The method as in claim 12, wherein identifying relevant information includes determining which compliance issues are applicable to a site associated with the industry user.

16. The method as in claim 1, wherein obtaining information from the industry user includes obtaining information using a graphical user interface.

17. The method as in claim 16, wherein using a graphical user interface includes displaying fill-in forms.

18. The method as in claim 1, wherein the information is associated with a compliance issue.

19. The method as in claim 18, wherein the compliance issue is selected from the group consisting of: a permit requirement, a record keeping requirement, a monitoring requirement, a reporting requirement, an audit, an inspection, an incident, a notification or an enforcement action.

20. The method as in claim 1, wherein at least one of the plurality of compliance agencies is an environmental regulation agency.

21. The method as in claim 1, wherein the information network is the Internet.

22. A method comprising:
receiving a login request from an industry user, wherein the industry user is associated with a compliance site;
obtaining information associated with attributes of the compliance site;
identifying compliance issues based on the attributes of the compliance site;
presenting, to the industry user, information associated with the identified compliance issues.

23. The method as in claim 22, wherein the attributes of the compliance site include a geographical location.

24. The method as in claim 22, wherein the attributes of the compliance site include an industry classification.

25. The method as in claim 22, wherein the attributes of the compliance site include a compliance history.

26. The method as in claim 22, wherein identifying compliance issues includes identifying a responsible compliance agency.

27. The method as in claim 22, wherein identifying compliance issues includes identifying compliance requirements.

28. The method as in claim 22, wherein identifying compliance issues includes using geospatial information and regulatory information.

29. The method as in claim 22, wherein presenting the information includes using a graphical user interface.

30. The method as in claim 22, wherein presenting information includes displaying forms.

31. The method as in claim 22, wherein presenting information includes displaying reports.

32. The method as in claim 22, wherein the compliance issue is selected from the group consisting of: a permit requirement, a record keeping requirement, a monitoring requirement, a reporting requirement, an audit, an inspection, an incident, a notification or an enforcement action.

33. The method as in claim 22, the compliance issues are issues associated with an environmental regulation agency.

34. The method as in claim 22, further including
obtaining industry user input associated with the information presented;
providing the industry user input, via an information network, to at least one compliance agency of the plurality of compliance agencies;
obtaining, from the at least one compliance agency, a response to the industry user input; and
providing the response to the industry user via the information network.

35. A method comprising:
obtaining, from a compliance agency, information associated with a compliance issue of a plurality of industry users; and
providing the plurality of industry users access to the information in a form compatible with data systems of the plurality of industry users.

36. The method as in claim 35, wherein obtaining information includes receiving the information via an information network.

37. The method as in claim 35, wherein the information associated with a compliance issue is selected from the group consisting of: an assignment, a status, a remedial action, an evaluation, a resolution, or a penalty.

38. The method as in claim 35, wherein the compliance issue is selected from the group consisting of: a permit requirement, a record keeping requirement, a monitoring requirement, a reporting requirement, an audit, an inspection, an incident or an enforcement action.

39. The method as in claim 35, wherein providing access includes delivering the information to the industry user via an information network.

40. A computer readable medium tangibly embodying a program of instructions, said program of instructions comprising:
at least one instruction to obtain, from an industry user via an information network, information to be delivered to a plurality of compliance agencies; and
at least one instruction to deliver the information to at least one compliance agency of the plurality of compliance agencies via the information network.

41. The computer readable medium as in claim 40, wherein the information is non-duplicative.

42. The computer readable medium as in claim 40, further including at least one instruction to validate the information to be delivered.

43. The computer readable medium as in claim 42, wherein the at least one instruction to validate the information includes at least one instruction to verify accuracy of the information.

44. The computer readable medium as in claim 42, wherein the at least one instruction to validate the information includes at least one instruction to authenticate a source of the information.

45. The computer readable medium as in claim 40, wherein said program of instructions further includes:
at least one instruction to obtain, from a compliance agency via an information network, information to be delivered to the industry user; and
at least one instruction to deliver the information to the user via the information network.

46. The computer readable medium as in claim 40, wherein:
the information obtained from the industry user is in a form compatible with a data system of the industry user; and
the information is delivered to the at least one compliance agency in a form compatible with a data system of the at least one compliance agency.

47. The computer readable medium as in claim 40, wherein the at least one instruction to deliver the information to the at least one compliance agency includes:
at least one instruction to notify the at least one compliance agency that the information has been obtained from the industry user;
at least one instruction to receive a reply to the notification from the at least one compliance agency; and
at least one instruction to provide the information to the at least one compliance agency in response to the reply.

48. The computer readable medium as in claim 40, wherein delivering the information to the at least one compliance agency includes storing the information in a database accessible to the at least one compliance agency.

49. The computer readable medium as in claim 40, wherein said at least one instruction to obtain information from the user includes:
at least one instruction to identify information relevant to the compliance requirement; and
at least one instruction to present the relevant information to the industry user.

50. The computer readable medium as in claim 49, wherein said at least one instruction to identify relevant information includes at least one instruction to identify a responsible compliance agency.

51. The computer readable medium as in claim 50, wherein said at least one instruction to identify a responsible compliance agency includes at least one instruction to apply a jurisdictional boundary.

52. The computer readable medium as in claim 50, wherein said at least one instruction to identify relevant information includes at least one instruction to determine which compliance issues are applicable to a site associated with the industry user.

53. The computer readable medium as in claim 40, wherein said at least one instruction to obtain information from the industry user includes at least one instruction to obtain information using a graphical user interface.

54. The computer readable medium as in claim 53, wherein said at least one instruction to obtain information using a graphical user interface includes at least one instruction to display fill-in forms.

55. The computer readable medium as in claim 40, wherein the compliance agency is an environmental regulation agency.

56. The computer readable medium as in claim 40, wherein the information network is the Internet.

57. A system comprising:
at least one processor;
memory operably associated with said process;
a program of instructions to be stored in said memory and executed by said processor, said program of instructions including instructions to:
obtain, from an industry user via an information network, information to be delivered to a plurality of compliance agencies; and
deliver the information to at least one compliance agency of the plurality of compliance agencies via the information network.

58. The system as in claim 57, wherein the information is non-duplicative.

59. The system as in claim 57, wherein said instructions further include instructions to validate the information to be delivered.

60. The system as in claim 57, wherein said instructions further include instructions to:
obtain, from a compliance agency via an information network, information to be delivered to an industry user; and
deliver the information to the industry user via the information network.

61. The system as in claim 57, wherein:
the information obtained from the industry user is in a form compatible with a data system of the industry user; and
the information is delivered to the at least one compliance agency in a form compatible with a data system of the at least one compliance agency.

62. The system as in claim 57, wherein the instructions to deliver the information to the at least one compliance agency include instructions to:
notify the at least one compliance agency that the information has been obtained from the industry user;
receive a reply to the notification from the at least one compliance agency; and
provide the information to the at least one compliance agency in response to the reply.

63. The system as in claim 57, wherein delivering the information to the at least one compliance agency includes storing the information in a database accessible to the at least one compliance agency.

64. The system as in claim 57, wherein said instructions to obtain information from the user include instructions to:
identify information relevant to the compliance requirement; and
present the relevant information to the user.

65. The system as in claim 64, wherein said instructions to identify relevant information include instructions to identify a responsible compliance agency.

66. The system as in claim 65, wherein said instructions to identify a responsible compliance agency include instructions to apply a jurisdictional boundary.

67. The system as in claim 64, wherein said instructions to identify relevant information include instructions to determine which compliance issues are applicable to a site associated with the industry user.

68. The system as in claim 57, wherein said instructions to obtain information from the industry user include instructions to obtain information using a graphical user interface.

69. The system as in claim 68, wherein said instructions to obtain information using a graphical user interface include instructions to display fill-in forms.

70. The system as in claim 57, wherein the compliance issue is selected from the group consisting of: a permit requirement, a record keeping requirement, a monitoring requirement, a reporting requirement, an audit, an inspection, an incident, a notification or an enforcement action.

71. The system as in claim 57, wherein the compliance agency is an environmental regulation agency.
